(19) United States
(12) Patent Application Publication
(10) Pub. No.: US 2020/0303790 A1
(43) Pub. Date: Sep. 24, 2020

(54) BATTERY CELL WITH PHASE CHANGE CORE

(71) Applicants: Chongqing Jinkang New Energy Automobile Co., Ltd., Chongqing (CN); SF Motors Inc., Santa Clara, CA (US)

(72) Inventors: Brennan Campbell, Santa Clara, CA (US); Scott Monismith, Santa Clara, CA (US); Derek Wong, Santa Clara, CA (US); Ying Liu, Santa Clara, CA (US); Yifan Tang, Santa Clara, CA (US)

(21) Appl. No.: 16/358,677

(22) Filed: Mar. 19, 2019

(51) Int. Cl. H01M 10/659; H01M 10/643; H01M 10/625; H01M 10/0525; H01M 10/613

(52) U.S. Cl. CPC H01M 10/659; H01M 10/643; H01M 2220/20; H01M 10/0525; H01M 10/613; H01M 10/625

(57) ABSTRACT

Embodiments disclosed herein may be generated related to the prevention of a thermal catastrophic event within a battery cell. A thermal catastrophic event may be caused by many issues associated with a battery cell such as an internal short within the battery cell. To prevent a thermal catastrophic event an apparatus that may include a battery cell and a phase change material in contact with one or more portions of the battery cell. The phase change material may be configured to change phases at a temperature that is close to that of a thermal runaway event. The phase change material may further have a high heat of fusion such that the phase change material may absorb heat within a battery cell in the case of thermal runaway event in order to prevent a thermal catastrophic event within the battery cell.

### BACKGROUND OF THE INVENTION

Electric vehicles (EVs) have emerged as a viable solution to replace traditional gas-combustion engine vehicles. One of the reasons of this emergence is the development of battery technology and in particularly the development of lithium ion batteries. While battery cells may offer performance and environmental advantages over gas-combustion engines they may also have disadvantages. Once such disadvantage is the potential of a thermal runaway event and the subsequent combustion of a battery cell. Elements that make up battery cells (especially lithium) may be flammable and thus if one or more parts of a battery cell fails a thermal runaway event may ensue. To make matter worse, if one battery cell within a battery experiences a thermal runaway event the excessive heat generated may cause a neighboring battery cell to begin a thermal runaway event, and this process may eventually cause one or more or all battery cells within a battery to experience a thermal runaway event. As a result, it is imperative to implement a solution that makes battery cells within EVs safer by preventing an extreme or catastrophic event in the situation in which there is a thermal runaway.

### BRIEF SUMMARY OF THE INVENTION

Embodiments disclosed herein may be generated related to the prevention of a thermal catastrophic event within a battery cell. A thermal catastrophic event may be caused by many issues associated with a battery cell such as an internal short within the battery cell. To prevent a thermal catastrophic event an apparatus is provided that may comprise a battery cell. The battery cell may comprise an anode, a cathode, and a separator between the anode and cathode. The separator may have a first melting temperature. The apparatus may further comprise a phase change material in contact with one or more components of the battery cell. The phase change material may have a second melting temperature being different than the first melting temperature. The second melting temperature may be lower than the first melting temperature. In such an embodiment, the phase change material may be in contact with or surrounded by the separator.

In one embodiment, the battery cell is a cylindrical battery cell and the phase change material is located in the center of the cylindrical battery. In such an embodiment, the phase change material may be surrounded by a first material such as polyethylene or polypropylene to prevent the phase change material from being exposed to the battery cell prematurely. In one embodiment, the phase change material may be comprised of sodium perchlorate. In one embodiment, the phase change material may have a heat of fusion of at least 85 kilojoules/kilograms so that it may absorb an amount of heat within the battery cell to prevent a thermal catastrophic event in the case of a thermal runaway event.

In one embodiment, the battery cell may be a pouch battery cell or a planar battery cell. There may be a casing that surrounds the battery cell and the phase change material may be in contact with the casing of the battery cell. For example, the phase change material may surround the casing of the battery cell. In another example, the phase change material may be attached to or affixed to the interior of the battery cell. Regardless of where the phase change material is located it may absorb heat within a battery cell in the case of a thermal runaway event.

### BRIEF DESCRIPTION OF THE DRAWINGS

FIG. 1 depicts a first battery cell in accordance with one or more embodiments.

FIG. 2 depicts a second battery cell in accordance with one or more embodiments.

FIG. 3 illustrates a battery manufacturing process in accordance with one or more embodiments.

Features, embodiments, and advantages of the present disclosure are better understood when the following Detailed Description is read with reference to the accompanying drawings.

### DETAILED DESCRIPTION OF THE INVENTION

The components of battery cells, especially lithium ion battery cells, may be susceptible to a thermal runaway event. Thermal runaway may occur in instances where an increase in temperature changes the condition (e.g., chemical reactions) of a battery cell. These changed conditions may cause an additional increase in temperature within the battery cell that may eventually lead to a catastrophic event such as explosion or combustion. As a result of the possibility of a thermal runaway event, certain safety measures may be implemented to help mitigate a thermal runaway event. Such security measures as utilizing a separator, electrolyte additives, and specialized caps may be somewhat helpful, but these security measures attempt to stop a thermal runaway event before it starts, but these security measures do not address mitigating a catastrophic event in case of thermal runaway. In addition, most security measures are aimed at preventing external short circuits within a battery cell, because short circuits present one path to a thermal runaway event. However, if a short circuit does occur there needs to be a way to stymie thermal runaway or at least mitigate thermal runaway to prevent explosion, combustion, or other catastrophic events.

One such way to prevent a catastrophic event in the case of a thermal runaway event is to utilize one or more phase change materials that may absorb a lot of heat. These phase change materials may, in some embodiments, be organic, inorganic, salts, and the like. Regardless of the material make-up of the phase change material it should have a high heat capacity and an extensive plateau in a plot of heat input versus temperature. The idea of implementing these materials to mitigate a catastrophic event is that these materials may absorb enormous amounts of heat during thermal runaway. An objective of the architecture disclosed by one or more embodiments is to absorb the heat generated during a thermal runaway event via the process of melting the phase change material. In one embodiment, the specific molar enthalpy of fusion of the phase change material is less than or equal to the total energy required to bring on/perpetuate thermal runaway. In one embodiment, a phase change material may have a total enthalpy of fusion close to the total heat generated by a thermal runaway event so that all the energy is consumed in the process of melting the phase change material.

Phase change material may be added to one or more portions of a battery cell to prevent a catastrophic event. In one embodiment, a column of phase change material may be inserted into the center of a cylindrical battery cell. The phase change material may be encased in a polyethylene film, polypropylene film, or a similar material. The polyethylene film may have a melting point of approximately 105-115 degrees Celsius. In one embodiment, the phase change material may be salt with a melting point of 200-800 degrees Celsius or an organic material such as paraffin wax with a melting point of 46-68 degrees Celsius. In the event of a short circuit, the polyethylene film may melt at high temperature (prior to thermal runaway) and the phase change material will melt either beforehand or afterwards. In either case, the short circuit will commence, but most of or all of the heat caused by the short circuit will be absorbed by the phase change of the phase change material that will seep through the battery cell as a result of the polyethylene being melted and the phase change material changing phase. The seeping phase change material will dissipate throughout the battery cell and absorb heat. Even if the battery cell goes into thermal runaway after the phase change material has changed phases the amount of heat produced from the thermal runaway will be mitigated which may reduce the chance of explosion or other catastrophic events.

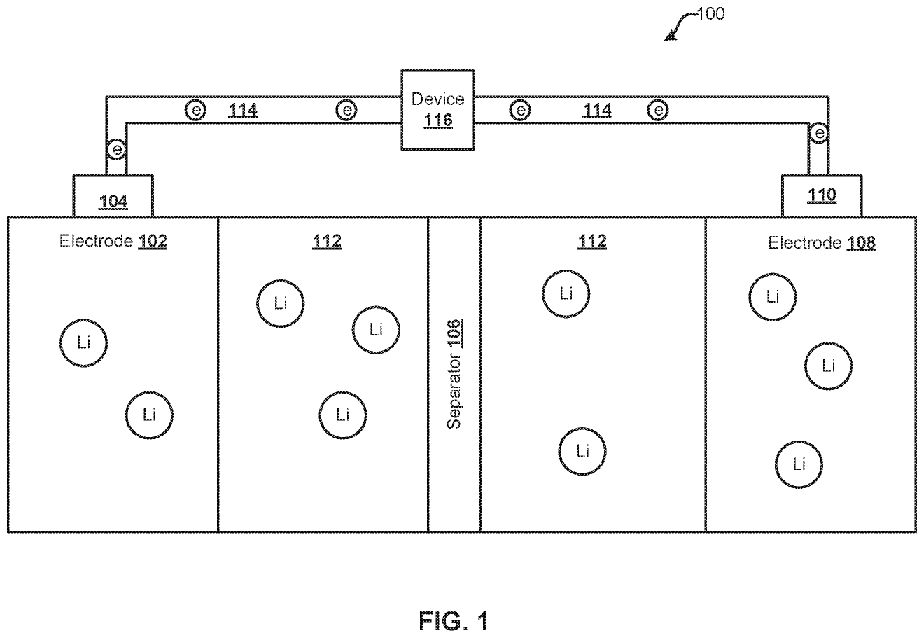

FIG. 1 depicts example cell 100 that may be implemented by one or more embodiments. Cell 100 may be a cell within a Lithium Ion (Li-ion) battery. Cell 100 produces electrical energy from chemical reactions. Cell 100 may be repeatedly charged and discharged. Cell 100 may comprise electrode 102, terminal 104, separator 106, electrode 108, terminal 110, electrolyte 112 and electron path 114.

Electrode 102 may be a positive electrode (e.g., a cathode) comprised of different material types. For example, electrode 102 may be comprised of lithium-cobalt oxide (LiCoO₂), lithium iron phosphate (LiFePO₄), and/or another metal based alloy. Electrode 102 may, prior to the initiation of a charging process, contain a plurality of lithium ions. During the charging process, the lithium ions (e.g., positively charged lithium ions) within electrode 102 may flow, via electrolyte 112, through separator 106 to electrode 108. During a discharging process the opposite may take place and the lithium ions within electrode 108 may flow, via electrolyte 112, though separator 106 and back to electrode 102. Although electrolyte 112 is shown as a separate component within battery cell 100, in many instances, electrodes 102 and 108 may be soaked in electrolyte 112 such that lithium ions may flow between electrode 102 and electrode 108 via separator 106.

Terminal 104 may be a current collector attached to electrode 102. Terminal 104 may be a positive current collector. Terminal 104 may be comprised of various materials including, but not limited to, copper, nickel, and/or compounds including copper and/or nickel. During a charging process, lithium ions within electrode 102 may flow from electrode 102 and electrons may be released. These electrons may flow from electrode 102 to terminal 104 and then from terminal 104, via electron path 114, to terminal 110. Because current flows in the opposite direction of electrons, terminal 104 may collect current during the charging process. Separator 106 may separate electrode 102 and electrode 108 while allowing lithium ions to flow between electrode 102 and electrode 108. Separator 106 may be a microporous isolator with little to no electrical conductivity. Separator 106 may also prevent the flow of electrons within electrolyte 112. By preventing electrons to flow within electrolyte 112, separator 106 may force electrons to flow via electron path 114. Separator 106 may be comprised of various microporous materials, including, but not limited to, polyolefin, polyethylene, polypropylene, and similar compounds.

Electrode 108 may be a negative electrode (e.g., an anode) comprised of different material types. For example, electrode 108 may be comprised of carbon (e.g., graphite), cobalt, nickel, manganese, aluminum, and/or compounds including carbon, cobalt, nickel, manganese, and/or aluminum. Electrode 108 may, prior to the initiation of a charging process, contain none of or a small amount of lithium ions. During the charging process, the lithium ions (e.g., positively charged lithium ions) within electrode 102 may flow, via electrolyte 112, through separator 106 and to electrode 108. During a discharging process, the opposite may take place and the lithium ions within electrode 108 may flow, via electrolyte 112, though separator 106 and to electrode 102.

Terminal 110 may be a current collector attached to electrode 108. Terminal 110 may be a negative current collector. Terminal 110 may be comprised of various materials including, but not limited to, aluminum and/or aluminum based compounds. During a charging process, electrons may flow to from electrode 102 to terminal 104 and then from terminal 104, via electron path 114, to terminal 110. Because current flows in the opposite direction of electrons, terminal 110 may collect current during a discharging process (e.g., when lithium ions flow from electrode 108 to electrode 102).

Electrolyte 112 may be solution of solvents, salts, and/or additivities that acts as a transport medium for lithium ions. Lithium ions may flow between electrodes 102 and 108 via electrolyte 112. In one embodiment, when an external voltage is applied to one of or both of electrodes 102 and 108 the ions in electrolyte 112 are attracted to an electrode with the opposite charge. For example, when external voltage is applied to cell 100, the lithium ions may flow from electrode 102 to electrode 108. The flow of ions within electrolyte 112 is due to the fact that electrolyte 112 has a high ionic conductivity due to the material make up of electrolyte 112. Electrolyte 112 may be comprised of various materials such as ethylene carbonate (EC), dimethyl carbonate (DMC), and/or lithium salts (e.g., LiClO₄, LiPF₆, and the like). In a solid state version of cell 100, electrolyte 112 may be a solid and may act as the separator. In such an embodiment the solid electrolyte may act as the separator between the electrode 102 and electrode 108, replacing separator 106.

Electron path 114 may be a path through which electrons flow between electrode 102 and electrode 108. Separator 106 may allow the flow of lithium ions between electrode 102 and electrode 108 via electrolyte 112, but separator 106 may also prevent the flow of electrons between electrode 102 and electrode 108 via electrolyte 112. Because the electrons cannot flow via electrolyte 112, they instead flow between electrode 102 and electrode 108 via electron path 114. In one embodiment, device 116 may be attached to electron path 114 and during a discharging process the electrons flowing through electron path 114 (from electrode 108 to electrode 102) may power device 116. In one embodiment, device 116 may only be attached to electron path 114 during a discharge process. In such an embodiment, during a charging process when an external voltage is applied to cell 100, device 116 may be directly powered or partially powered by the external voltage source.

Device 116 may be a parasitic load attached to cell 100. Device 116 may operate based at least in part off of current produced by cell 100. Device 116 may be various devices such as an electronic motor, a laptop, a computing device, a processor, and/or one or more electronic devices. Device 116 may not be a part of cell 100, but instead relies on cell 100 for electrical power. For example, device 116 may be an electronic motor that receives electric energy from cell 100 via electron path 114 and device 116 may convert the electric energy into mechanical energy to perform one or more functions such as acceleration in an EV. During a charging process, when an external power source is connected to cell 100, device 116 may be powered by the external power source (e.g., external to cell 100). During a discharging process, when an external power source is not connected to cell 100, device 116 may be powered by cell 100.

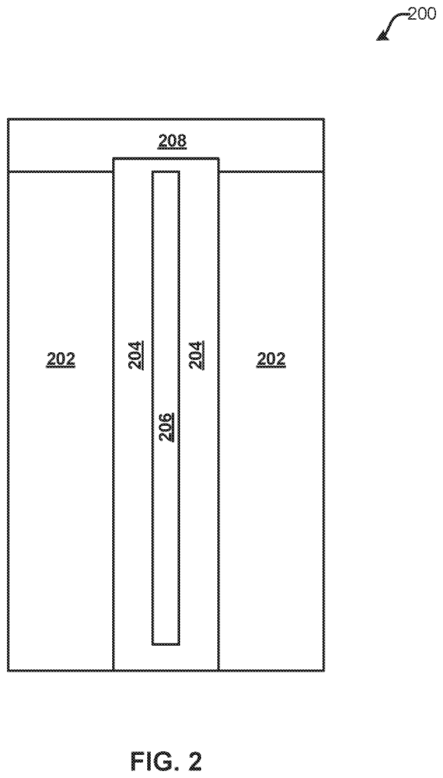

FIG. 2 depicts example cell 200 that may be implemented by one or more embodiments. Cell 200 is a cylindrical battery cell. Cell 200 comprises jelly roll 202, film 204, phase change material 206, and cap 208. Jelly roll 202 may comprise sheets of anodes, cathodes, and a separator. Specifically, each anode sheet and cathode sheet is separated by a separator sheet. These three sheets may be rolled together in order to form a cylinder structure comprising multiple layers. In a jelly roll the center may be hallow. The center of jelly roll 202 may be occupied by film 204 and phase change material 206.

Film 204 may be a polyethylene film or a similar material. In one embodiment, the melting point of film 204 may be between 105-115 degrees Celsius. In one embodiment, film 204 may be omitted when there are rounds of a separator from jelly roll 202 surrounding the hollow center of jelly roll 202. For example, when winding the anode sheet, cathode sheet, and separator sheets together to form jelly roll 202, the anode and cathode sheets may expire and there may be one or two more rounds of the separator sheet. In such an example, film 204 may be omitted and the excess rounds of the separator sheet may act as film 204.

Phase change material 206 may a material or combination of materials that may change from a solid to a liquid at a certain temperature in order to absorb heat within cell 200. In one embodiment, the phase change temperature (melting point) of phase change material 206 should be close to a thermal runaway temperature. The thermal runaway temperature may vary from battery cell to battery cell. If the phase change temperature is too high (as compared to a thermal runaway temperature) then phase change material 206 may undergo a phase change too late and it won't be able to absorb the heat to prevent or slow down a thermal runaway event. If the phase change temperature is too low (as compared to thermal runaway temperature) then phase change material 206 may change phases too early and absorb heat in cases where a thermal runaway event is not happening or likely to happen. For example, if cell 200 has a thermal runaway temperature of 130 degrees, meaning a thermal runaway event commences when the temperature of cell 200 reaches 130 degrees, phase change material 206 should change phases soon thereafter to prevent a dramatic increase of heat which would lead to a catastrophic event if allowed to continue. In such an example, phase change material 206 may be a salt with a phase change temperature of 200 degrees Celsius. In one embodiment, the range of temperatures that have the highest probability of igniting a thermal runaway event are determined for certain battery cells based on their battery cell chemistry. Once the range of temperatures are determined, then a suitable phase change material may be determined.

In one embodiment, phase change material 206 may be implemented as table salt, a salt with a melting point between 200 to 800 degrees Celsius, a paraffin wax with a melting point between 46 to 68 degrees Celsius. The following table shows a list of potential phase change materials, but is not intended to a limiting list, instead a phase change material may be selected based on a battery cell's chemistry.

TABLE 1
Phase Change Compounds

| | Melting | Heat of | |
|---|---|---|---|
| | Temperature | Fusion | Thermal conductivity |
| Compound | (Celsius) | (kJ/kg) | (W/mK) |
| Paraffin C₁₄ | 4.5 | 165 | Not available (n.a.) |
| Paraffin C₁₄-C₁₆ | 8 | 153 | n.a. |
| Polygylcol E400 | 8 | 99.6 | 0.187 (liquid, 38.6° C.) |
| | | | 0.185 (liquid, 69.9° C.) |
| Dimethyl-sulfoxide (DMS) | 16.5 | 85.7 | n.a. |
| Paraffin C₁₆-C₁₈ | 20-22 | 152 | n.a. |
| Polyglycol E600 | 22 | 127.2 | 0.189 (liquid, 38.6° C.) |
| | | | 0.187 (liquid, 67° C.) |
| Paraffin C₁₃-C₂₄ | 22-24 | 189 | 0.21 (solid) |
| 1-Dodecanol | 26 | 200 | n.a. |
| Paraffin C₁₈ | 28 | 244 | 0.148 (liquid, 40° C.) |
| 1-Tetradecanol | 38 | 205 | 0.358 (solid, 25° C.) |
| Paraffin C₁₆-C₂₈ | 42-44 | 189 | 0.21 (solid) |
| Paraffin C₂₀-C₃₃ | 48-50 | 189 | 0.21 (solid) |
| Paraffin C₂₂-C₄₅ | 58-60 | 189 | 0.21 (solid) |
| Paraffin wax | 64 | 173.6 | 0.167 (liquid, 63.5° C.) |
| | | 266 | 0.346 (solid, 33.6° C.) |
| H₂O | 0 | 333 | 0.612 (liquid, 20° C.) |
| | | 334 | 0.61 (30° C.) |
| Mn(NO₃)₂ 6H₂O | 25.8 | 125.9 | n.a. |
| CaCl₂ 6H₂O | 29 | 190.8 | 0.540 (liquid, 38.7° C.) |
| | 29.2 | 171 | 0.561 (liquid, 61.2° C.) |
| | 29.6 | 174.4 | 1.088 (solid, 23° C.) |
| LiNO₃ 3H₂O | 30 | 296 | n.a. |
| Na₂SO₄ 10H₂O | 32.4 | 254 | 0.544 |
| Na₂CO₃ 10H₂O | 32-36 | 246.5 | n.a. |
| CaBr₂ 6H₂O | 34 | 115.5 | n.a. |
| 66.6% CaCl₂ 6H₂O + | 25 | 127 | n.a. |
| 33.3% MgCl₂ 6H₂O | | | |
| 48% CaCl₂ + 4.3% NaCl + | 26.8 | 188.0 | n.a. |
| 0.4% KCl + 47.3% H₂O | | | |
| 47% Ca(NO₃)₂ 4H₂O + | 30 | 136 | n.a. |
| 33% Mg(NO₃)₂ 6H₂O | | | |
| 60% Na(CH₃COO) 3H₂O + | 31.5 | 226 | n.a. |
| 40% CO(NH₂)₂ | | | |
| 61.5% Mg(NO₃)₂ 6H₂O + | 52 | 125.5 | 0.494 (liquid, 65.0° C.) |
| 38.5% NH₄ NO₃ | | | 0.515 (liquid, 88.0° C.) |
| | | | 0.552 (solid, 36.0° C.) |
| 58.7% Mg(NO₃) 6H₂O + | 59 | 132.2 | 0.510 (liquid, 65.0° C.) |
| 41.3% MgCl₂ 6H₂O | 58 | 132 | 0.565 (liquid, 85.0° C.) |
| | | | 0.678 (solid, 38.0° C.) |
| | | | 0.678 (solid, 53.0° C.) |
| 53% Mg(NO₃)₂ 6H₂O + | 61 | 148 | n.a. |
| 47% Al(NO₃)₂ 9H₂O | | | |
| 14% LiNO₃ + 86% Mg(NO₃)₂ | 72 | >180 | n.a. |
| 6H₂O | | | |

Although phase change material 206 is depicted as being only within the center of jelly roll 202 it is within the scope of embodiments described herein to place phase change material 206 at different locations. For example, phase change material 206 may be placed in the center of j elly roll 202, at the bottom of cell 200, within the separator of j elly roll 202, on top of cell 200, in between layers within jelly roll 202, and/or around the perimeter of cell 200. Regardless of where phase change material 206 is placed its purpose is the same, to absorb heat in the case of a thermal runaway event.

Cap 208 may affixed to cell 200 by a high compression method to seal cell 200. In one embodiment, a gasket may be implemented within cap 208 to prevent transmission of electricity between a positive terminal and negative terminal of cell 200. In one embodiment, a positive temperature coefficient (PTC) element may be implemented within cap 208. The PTC element may increase resistance dramatically above a certain temperature. Thus, the PTC element may attempt to prevent cell 200 from commencing a thermal runaway event by significantly limiting the current going in or out of cell 200, when cell 200 is above a certain temperature. Other various features may be included within or affiliated with cap 208, such as an anti-explosive value, an exhaust gas hole, and the like.

Cell 200 is depicted as a cylindrical cell, but it is within the scope of embodiments described herein to implement cell 200 according to a plurality of different cell structures. For example, cell 200 may be pouch structured cell, a prismatic structured cell, and the like. Regardless of the cell structure, phase change material 206 may be utilized to mitigate a thermal runaway event. For example, in an embodiment where cell 200 is a pouch structured cell, phase change material 206 may wrap around the perimeter of the pouch structured cell.

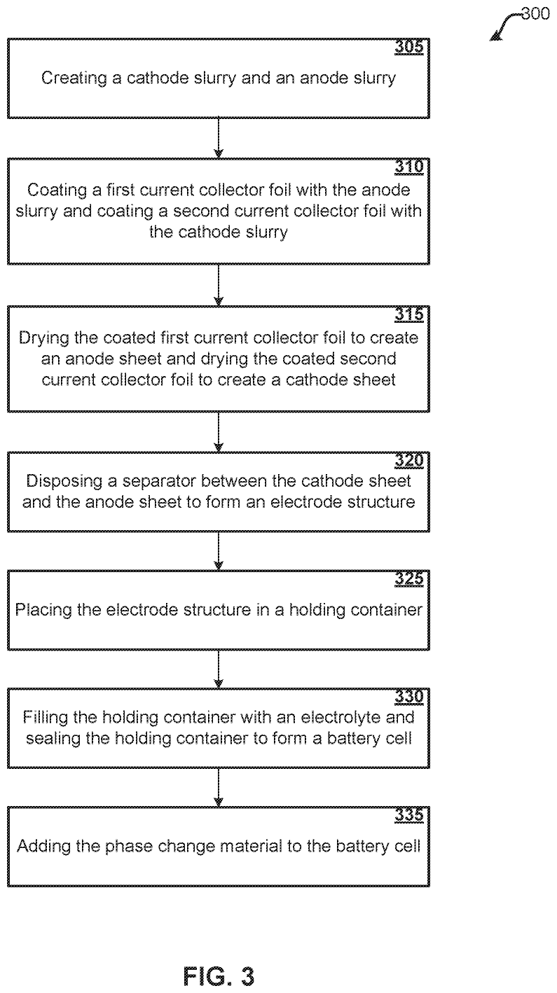

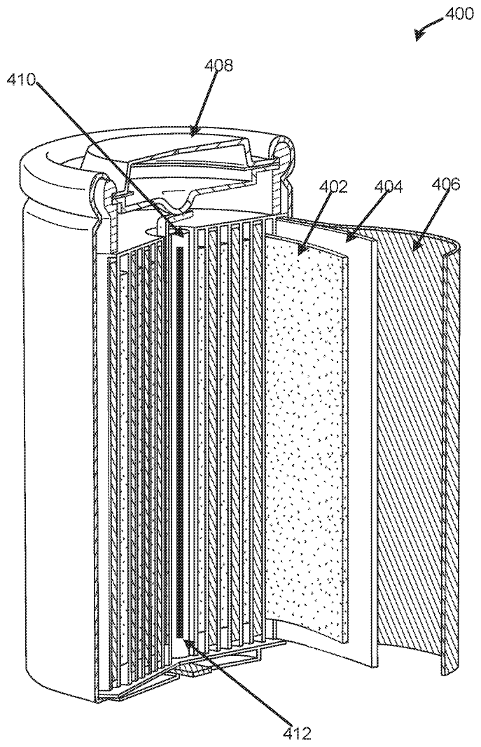

FIG. 3 illustrates process 300 for manufacturing a cell according to one or more embodiments. Process 300 may involve one or more manufacturing devices such as a slurry machine, foil coating machine, drying machine, one or more large reels and the like. At 305, a cathode slurry and an anode slurry are created. In one embodiment, the materials that make up a cathode and/or an anode may be received (e.g., at a manufacturing facility) in the form of a powder. For example, a cathode powder may be a powder form of LiCoO₂ or LiFePO₄. In another example, an anode powder may be a powder form of carbon (graphite). In one embodiment, the structural make up of an electrode powder may alter the electrical or chemical characteristics of the electrode. For example, electrode powders that contain particles with smooth spherical shapes and rounded edges may be ideal as electrode powders that contain particles with sharp or flakey surfaces may be susceptible to higher electrical stress and decomposition. Electrical stress and decomposition may lead to possible thermal runway when the electrode is in use within a cell. The cathode powder may be mixed with a conductive binder to form a cathode slurry. Similarly, the anode powder may be mixed with a conductive binder to form an anode slurry.

At 310, the anode slurry is coated onto a first current collector foil and the cathode slurry is coated onto a second current collector foil. The first current collector foil may be a foil that is specific to an anode slurry. For example, the first current collector foil may be a copper foil, nickel foil, or the like. The second current collector foil may be a foil that is specific to a cathode slurry. For example, the second current collector foil may be an aluminum foil and the like. Each current collector foil may be delivered by large reels and may be fed into separate coating machines. While in separate coating machines, each current collector foil has a corresponding slurry that is spread on its surface. For example, the first current collector foil may be fed, by a large reel, into an anode coating machine. While in the anode coating machine, the anode slurry produced at 305 may be spread on the surface of the first current collector foil as the first current collector foil passes through the anode coating machine. During the coating process, the thickness of a coated current collector foil may be modified such that the coated current collector foil has a desired thickness. In one embodiment, the thickness of the coated current collector foil may alter the energy storage per unit area of an electrode that is formed from that coated current collector foil.

At 315, the coated first current collector foil and the coated second current collector foil are dried. The coated current collector foils may be dried by feeding the coated current collector foils into a drying oven. Inside the drying oven, the respective electrode material (e.g., cathode or anode slurry) may be baked onto the coated current collector foil. Once the electrode material is baked onto a coated current collector foil, the coated current collector foil may be cut (e.g., width wise) into a size desired for a particular application. At the end of 315, an anode sheet may be formed from the processing applied to the first current collector foil and a cathode sheet may be formed from the processing applied to the second current collector foil. In one embodiment, the thickness of the cathode sheet and anode sheet is determined at 310 and the width of the cathode sheet and anode sheet is determined at 315.

At 320, a separator is disposed between the cathode sheet and the anode sheet forming an electrode structure. The separator may be a microporous insulator. In one embodiment, a separator may be disposed between the cathode sheet and anode sheet in a prismatic cell structure. In a prismatic cell structure, the cathode and anode sheets are cut into individual electrode plates and the separator is placed in the middle of the electrode plates. In one embodiment, the separator may be applied as a single long strip in a zig zag fashion. In such an embodiment, the separator would be woven in between alternate electrodes in the stack. For example, a first layer in the prismatic cell may be a first cathode sheet, the second layer may be a separator, the third layer may be a first anode sheet, the fourth layer may be the separator, the fifth layer may be a second cathode sheet, the sixth layer may be the separator, the seventh layer may be a second anode sheet, and so forth. This stacked configuration may be used for high capacity battery applications to optimize space.

In one embodiment, a separator may be disposed between the cathode sheet and anode sheet in a cylindrical cell structure. In a cylindrical cell structure, the cathode sheet, the separator, and the anode sheet are wound onto a cylindrical mandrel in such a way that the cathode sheet and anode sheet are separated by the separator. The result of this winding process is a jelly roll. An advantage of the cylindrical cell structure is that it requires only two electrode strips which simplifies the construction process over other structures (e.g., prismatic cell). A first tab may be included on the cathode sheet and a second tab may be included on the anode sheet. Each respective tab may be a connection point to the respective electrode (e.g., to connect to an external device).

In one embodiment, a phase change material may be placed between layers such that phase change material is within or within contact with the separator layer. In such an embodiment, the phase change material may be chosen such that when the separator layer melts the phase change material will be exposed and may commence (at some point after the separator melts) a phase change in order to absorb heat within the cell. In many instances, once the separator melts, the anode and cathode may come into immediate contact with each other causing an internal short circuit. At this point, the battery cell itself is mostly likely compromised beyond repair. Thus waiting for the separator to melt may be a reliable indication that a thermal runaway event from an internal short circuit is going to commence.

At 325, the electrode structure is placed in a holding container. The holding container may depend upon the cell structure of the electrode structure. For example, a holding container may be a can-shaped container for a cylindrical cell structure. At 330, once the electrode structure is inside the holding container the holding container is filled with an electrolyte and sealed. The filling of the holding container with the electrolyte may be referred to as an electrolyte wetting process. After the holding container is sealed the battery cell is formed. Once the battery cell is formed the battery cell may be charged and discharged once to activate the materials (e.g., cathode, anode, lithium ions, etc.) inside the battery cell to make the battery cell active. At 335, phase change material may be added to the battery cell. The phase change material may be added to the top, bottom, or around the perimeter of the battery cell. In the case of a thermal runaway event, the holding container may fail and at this point, the phase change material may change phases and absorb heat from the failed battery cell in order to prevent a catastrophic event. In one embodiment, the phase change material may be added to different parts of the battery cell in addition to or instead of being placed on the outside of the battery cell. For example, the phase change material may be placed within one or more separator layers, within the center of a jelly roll, and the like. In one embodiment, the phase change material may be covered with a film or the separator itself. For example, in a cylindrical battery cell there may be a couple of extra rounds of a separator at the center of the jelly roll. In such an example, phase change material may be inserted into the center of the jelly roll without a film and will be surrounded by the separator.

FIG. 4 depicts example cell 200 that may be manufactured as one or more processes associated with one or more embodiments. Cell 400 is a cylindrical battery cell. Cell 400 comprises electrode layer 402, insulator layer 404, electrode layer 406, cap 408, film 410, and phase change material 412. Electrode layer 402 may be a negatively charged electrode and electrode layer 406 may be an electrode layer of opposite charge (e.g. positively charge electrode). Electrode layer 402 and electrode layer 406 may be separator by insulator layer 404. In one embodiment, each of electrode layer 402, insulator layer 404, and electrode layer 406 may be sheets of various materials. For example electrode layer 402 may be a thin sheet of materials comprising carbon, insulator layer 404 may be a thin sheet of materials comprising polyethylene, electrode layer 406 may be a sheet of materials comprising lithium. Electrode layer 402, insulator layer 404, and electrode layer 406 may be a part of a jelly roll within cell 400. In one embodiment, insulator layer 404 and film 410 may be the same. Such an embodiment may depend up on the melting point of insulator layer 404. For example, if a melting point of insulator layer 404 is close to the temperature of a thermal runaway event within cell 400, then insulator layer 404 may function as film 410.

Cap 408 may affixed to cell 400 by a high compression method to seal cell 400. In one embodiment, a gasket may be implemented within cap 408 to prevent transmission of electricity between a positive terminal and negative terminal of cell 400. Film 410 may be a film that encapsulates phase change material 412. Film 410 may be chosen based upon the melting point of film 410 and the configuration of phase change material 412. In a first configuration, film 410 may encapsulate phase change material 412. In such a configuration, the melting point of film 410 may need to be below the temperature for phase change material 412 to change phases. For example, film 410 may have melting point of 130 degrees and phase change material 412 may have a melting point of 25 degrees. In the first configuration, the temperature for phase change of phase change material 412 may not be material because phase change material 412 is contained by film 410, and may only be exposed to cell 400 when film 410 has melted. This may mean phase change material 412 may be selected primary based on its heat of fusion, which is amount of energy phase change material 412 can absorb. For example, film 410 may have a melting point of 130 degrees and phase change material 412 may be LiNO₃ 3H₂O with a heat of fusion of 296 kJ/kg and a melting point of 30 degrees. In such an example, phase change material 412 may have a relatively low melting point because film 410 may protect phase change material 412 from being exposed to and potentially ruining cell 400 prior to film 410 melting. This may allow phase change material 412 to be selected primary based on its ability to absorb heat.

In a second configuration, film 410 may not encapsulate phase change material 412. In such a configuration, the temperature for phase change material 412 to change phases may be based upon probability of igniting a thermal runaway event for certain battery cells based on their battery cell chemistry. For example, if cell 400 initiates a thermal runaway event at 130 degrees, then the temperature for phase change material 412 to change phases may be 135 degrees, 140 degrees or the like. In the second configuration, the temperature for phase change for phase change material 412 may need to be close to the temperature of a thermal runaway event to prevent phase change material 412 from changing phases prior to a thermal runaway event. Otherwise, phase change material 412 may change phases at a temperature not indicative of a thermal runaway (e.g. 25 degrees) and may prematurely ruin battery cell 400. In one embodiment, sodium perchlorate (NaClO₄) may be utilized as phase change material 412 when phase change material 412 is not encapsulated by film 410. Sodium perchlorate may change from a solid to a liquid at 130 degrees and thus may be utilized in cell 400 if the battery chemistry of cell 400 experiences thermal runaway around 130 degrees. In some embodiments sodium perchlorate may be utilized in the first configuration.

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, it should be understood that the present disclosure has been presented for purposes of example rather than limitation, and does not preclude inclusion of such modifications, variations, and/or additions to the present subject matter as would be readily apparent to one of ordinary skill in the art. Indeed, the methods and systems described herein may be embodied in a variety of other forms; furthermore, various omissions, substitutions and changes in the form of the methods and systems described herein may be made without departing from the spirit of the present disclosure. The accompanying claims and their equivalents are intended to cover such forms or modifications as would fall within the scope and spirit of the present disclosure.

Conditional language used herein, such as, among others, “can,” “could,” “might,” “may,” “e.g.,” and the like, unless specifically stated otherwise, or otherwise understood within the context as used, is generally intended to convey that certain examples include, while other examples do not include, certain features, elements, and/or steps. Thus, such conditional language is not generally intended to imply that features, elements and/or steps are in any way required for one or more examples or that one or more examples necessarily include logic for deciding, with or without author input or prompting, whether these features, elements and/or steps are included or are to be performed in any particular example.

The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Similarly, the use of “based at least in part on” is meant to be open and inclusive, in that a process, step, calculation, or other action “based at least in part on” one or more recited conditions or values may, in practice, be based on additional conditions or values beyond those recited. Headings, lists, and numbering included herein are for ease of explanation only and are not meant to be limiting.

The various features and processes described above may be used independently of one another, or may be combined in various ways. All possible combinations and sub-combinations are intended to fall within the scope of the present disclosure. In addition, certain method or process blocks may be omitted in some embodiments. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed examples. Similarly, the example systems and components described herein may be configured differently than described. For example, elements may be added to, removed from, or rearranged compared to the disclosed examples.

1. An apparatus for preventing combustion of a battery cell, comprising:
a battery cell, comprising an anode, a cathode, and a separator between the anode and cathode, wherein the separator has a first melting temperature; and
a phase change material in contact with one or more components of the battery cell, the phase change material having a second melting temperature being different than the first melting temperature.

2. The apparatus of claim 1, wherein the phase change material is in contact with the separator.

3. The apparatus of claim 1, wherein the battery cell is a cylindrical battery cell and the phase change material is located in the center of the cylindrical battery.

4. The apparatus of claim 3, wherein the phase change material is surrounded by a first material.

5. The apparatus of claim 4, wherein the first material comprises of polyethylene or polypropylene.

6. The apparatus of claim 1, wherein the battery cell is a pouch battery cell or planar battery cell, and the battery cell further comprising a casing located on a perimeter of the battery cell, the casing being surrounded by the phase change material.

7. The apparatus of claim 1, wherein the phase change material is configured to change from a solid to a liquid at the second melting temperature.

8. The apparatus of claim 1, wherein the phase change material is sodium perchlorate

9. The apparatus of claim 1, wherein the phase change material has a heat of fusion of at least 85 kilojoules/kilograms.

10. The apparatus of claim 1, wherein the phase change material is in contact with the perimeter of the battery cell.

11. A method for preventing combustion of a battery cell, comprising:
placing a separator between an anode and a cathode, wherein the separator has a first melting temperature; and
placing a phase change material in contact with one or more components of the battery cell, the phase change material having a second melting temperature being different than the first melting temperature.

12. The method of claim 11, further comprising surrounding the phase change material with the separator.

13. The method of claim 11, wherein the battery cell is a cylindrical battery cell and the phase change material is located in the center of the cylindrical battery.

14. The method of claim 13, wherein the phase change material is surrounded by a first material.

15. The method of claim 14, wherein the first material comprises of polyethylene or polypropylene.

16. The method of claim 11, wherein the battery cell is a pouch battery cell or planar battery cell, and the method further comprising:
placing the battery cell inside a casing, wherein the casing contacts the perimeter of the battery cell; and
placing the phase change material in contact with the casing.

17. The method of claim 11, wherein the phase change material is configured to change from a solid to a liquid at the second melting temperature.

18. The method of claim 11, wherein the phase change material is sodium perchlorate

19. The method of claim 11, wherein the phase change material has a heat of fusion of at least 85 kilojoules/kilograms.

20. The method of claim 11, wherein the phase change material is in contact with the perimeter of the battery cell.
